(19) United States
(12) Patent Application Publication
(10) Pub. No.: US 2006/0181487 A1
(43) Pub. Date: Aug. 17, 2006

(54) PLASMA DISPLAY APPARATUS AND DRIVING METHOD THEREOF

(75) Inventors: Byung-Goo KONG, Yongin-si, Gyeonggi-do (KR); Seong-Hee PARK, Gunpo-si, Gyeonggi-do (KR); Jeong-Pil CHOI, Gwonseon-gu, Suwon-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Youngdungpo-gu, Seoul (KR)

(21) Appl. No.: 11/276,102

(22) Filed: Feb. 14, 2006

(30) Foreign Application Priority Data
Feb. 14, 2005 (KR) 1020050012093
Feb. 14, 2005 (KR) 1020050012094
Feb. 14, 2005 (KR) 1020050012095

(51) Int. Cl. G09G 3/28

(52) U.S. Cl. 345/60

(57) ABSTRACT

A plasma display apparatus and a driving method thereof are provided. The plasma display apparatus comprises a plurality of drivers. The plurality of drivers are formed on one board, respectively.

This Nonprovisional application claims priority under 35 U.S.C. § 119(a) on Patent Application Nos. 2005-12093, 2005-12094 and 2005-12095 filed in Korea on Feb. 14, 2005 the entire contents of which are hereby incorporated by reference.

### BACKGROUND OF THE INVENTION

1. Field of the Invention

This document relates to a plasma display apparatus and a driving method thereof.

2. Description of the Background Art

FIG. 1 shows a structure of a related art plasma display panel. As shown in FIG. 1, the related art plasma display panel comprises a front panel 100 and a rear panel 110. The front panel 100 comprises a front glass substrate 101 and the rear panel 110 comprises a rear glass substrate 111. The front panel 100 and the rear panel 110 are coupled in parallel at a given distance therebetween.

A scan electrode 102 and a sustain electrode 103 are formed on the front glass substrate 101 and maintain light-emissions of cells through a mutual discharge therebetween. The scan electrode 102 and the sustain electrode 103 each comprise transparent electrodes 102a and 103a and bus electrodes 102b and 103b. A scan pulse for scan of the panel and a sustain pulse for discharge maintenance of the cells are applied to the scan electrode 102. A sustain pulse for discharge maintenance of the cells is applied to the sustain electrode 103.

An upper dielectric layer 104 is formed on upper parts of the scan electrode 102 and the sustain electrode 103 to limit a discharge current and to provide insulation between the scan electrode 102 and the sustain electrode 103. A protective layer 105 is formed on an upper surface of the upper dielectric layer 104 and made of magnesium oxide (MgO) for facilitating discharge conditions.

An address electrode 113 is formed on the rear glass substrate 111 to intersect the scan electrode 102 and the sustain electrode 103. A lower dielectric layer 115 is formed on an upper part of the address electrode 113 to provide insulation between the address electrodes 113. Barrier ribs 112 are formed on the lower dielectric layer 115 to form discharge cells. A phosphor layer 114 is coated between the barrier ribs 112 to emit visible light.

A related art plasma display apparatus comprises a plasma display panel and a driving apparatus for driving the plasma display panel. The driving apparatus is mounted on a heat sink formed on a rear surface of the plasma display panel.

FIG. 2 shows a driving apparatus of a related art plasma display apparatus.

As shown in FIG. 2, a scan driver 220 comprises a scan driver board 221 and a Y-sustain board 223. The scan driver board 221 supplies a reset pulse and a scan pulse to scan electrodes of the plasma display panel through a Y-flexible printed circuit (Y-FPC) 251. The Y-sustain board 223 supplies a sustain pulse to the scan electrodes through the scan driver board 221 and the Y-FPC 251.

A sustain driver 230 comprises a Z-sustain board 231. The Z-sustain board 231 supplies a sustain pulse to sustain electrodes of the plasma display panel through a Z-FPC 253.

A data driver 240 comprises a data driver board 241. The data driver board 241 supplies an address pulse to address electrodes of the plasma display panel through a X-FPC 255.

A controller 210 supplies a Y-timing control signal to the scan driver 220 through a first FPC 257, a Z-timing control signal to the sustain driver 230 through a second FPC 259 and a X-timing control signal to the address driver 240 through a third FPC 261.

Generally, the scan driver 220 and the sustain driver 230 are mounted on one board, respectively. Recently, as a large-sized plasma display apparatus has been developed, the size of each of the driving boards on which the scan driver 220 and the sustain driver 230 are mounted has become larger. Accordingly, it is difficult to manipulate the scan driver 220 and the sustain driver 230 and the manufacturing cost of the plasma display apparatus increases.

Further, as the large-sized plasma display apparatus has been developed, since one driving board supplies a driving pulse to all of the electrodes, a control process is complicated and a driving margin decreases.

### SUMMARY OF THE INVENTION

Accordingly, an object of the present invention is to solve at least the problems and disadvantages of the background art.

Embodiments of the present invention provide a plasma display apparatus for reducing the manufacturing cost of the large-sized plasma display apparatus supporting a high definition, and a driving method thereof.

The embodiments of the present invention also provide a plasma display apparatus for simplifying a control process and preventing a decrease in a driving margin of the large-sized plasma display apparatus supporting a high definition, and a driving method thereof.

The embodiments of the present invention also provide a plasma display apparatus for preventing a reduction in driving efficiency of the large-sized plasma display apparatus supporting a high definition, and a driving method thereof.

According to an aspect, there is provided a plasma display apparatus comprising a plasma display panel on which a plurality of scan electrodes, a plurality of sustain electrodes and a plurality of address electrodes are formed and at least two scan drivers for driving the plurality of scan electrodes, wherein one of at least two scan drivers supply a first driving pulse to the plurality of scan electrodes, the other scan driver supplies a second driving pulse to the plurality of scan electrodes, and one scan driver and the other scan driver supply the first driving pulse and the second driving pulse at application time points different from each other.

According to an aspect, there is provided a method of driving a plasma display apparatus comprising supplying a first driving pulse to the plurality of scan electrodes and supplying a second driving pulse to the plurality of scan electrodes, wherein the first driving pulse and the second driving pulse are supplied at application time points different from each other.

The plasma display apparatus and the driving method thereof according to the embodiments of the present invention comprise a small-sized driving board which is easily manipulated.

The plasma display apparatus and the driving method thereof according to the embodiments of the present invention comprise the small-sized driving board, and thus the manufacturing cost of the plasma display apparatus decreases.

The plasma display apparatus and the driving method thereof according to the embodiments of the present invention simplify a control process and increase a driving margin.

The plasma display apparatus and the driving method thereof according to the embodiments of the present invention reduce the energy consumption and increase a driving efficiency.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 shows a structure of a related art plasma display panel;

FIG. 2 shows a driving apparatus of a related art plasma display apparatus;

FIG. 3 shows a plasma display apparatus according to a first embodiment of the present invention;

FIG. 4 illustrates a relationship between drivers and electrodes of the plasma display apparatus according to the first embodiment of the present invention;

FIG. 5 illustrates the energy consumption of the plasma display apparatus according to the first embodiment of the present invention;

FIG. 6 shows a plasma display apparatus according to a second embodiment of the present invention;

FIG. 7 illustrates a relationship between drivers and electrodes of the plasma display apparatus according to the second embodiment of the present invention;

FIG. 8 shows a plasma display apparatus according to a third embodiment of the present invention;

FIG. 9 illustrates a relationship between drivers and electrodes of the plasma display apparatus according to the third embodiment of the present invention;

FIG. 10 shows a plasma display apparatus according to a fourth embodiment of the present invention;

FIG. 11 illustrates a relationship between drivers and electrodes of the plasma display apparatus according to the fourth embodiment of the present invention;

FIG. 12 shows a plasma display apparatus according to a fifth embodiment of the present invention;

FIG. 13 illustrates a relationship between drivers and electrodes of the plasma display apparatus according to the fifth embodiment of the present invention; and

FIGS. 14a through 14d show a driving method of the plasma display apparatus according to the fifth embodiment of the present invention.

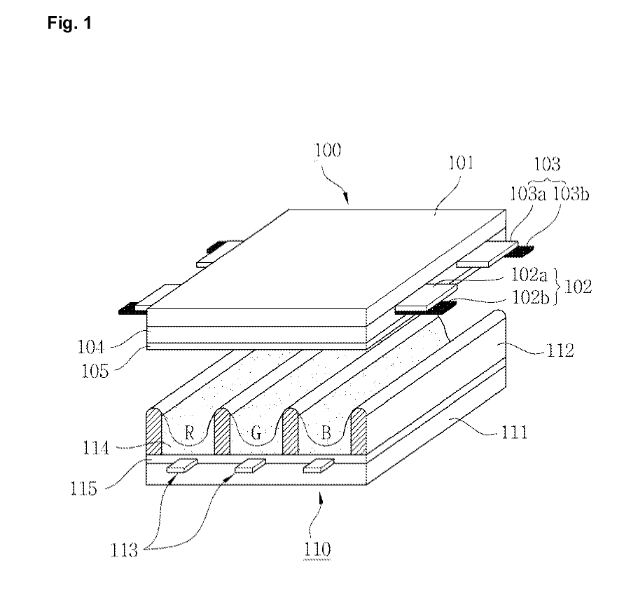

### DETAILED DESCRIPTION OF PREFERRED EMBODIMENTS

Embodiments of the present invention will be described in a more detailed manner with reference to the drawings.

According to an aspect, there is provided a plasma display apparatus comprising a plasma display panel on which a plurality of scan electrodes, a plurality of sustain electrodes and a plurality of address electrodes are formed and at least two scan drivers for driving the plurality of scan electrodes, wherein one of at least two scan drivers supply a first driving pulse to the plurality of scan electrodes, the other scan driver supplies a second driving pulse to the plurality of scan electrodes, and one scan driver and the other scan driver supply the first driving pulse and the second driving pulse at application time points different from each other.

The plasma display apparatus may further comprise at least one sustain driver for driving the plurality of sustain electrodes.

The plasma display apparatus may further comprise at least one data driver for driving the plurality of address electrodes.

The first driving pulse and the second driving pulse each may comprise at least one of a reset pulse, a scan pulse or a sustain pulse.

The first driving pulse may comprise a first reset pulse and the second driving pulse comprises a second reset pulse, and a slope of the first reset pulse is different from a slope of the second reset pulse.

A frame in which the first driving pulse is applied may be different from a frame to which the second driving pulse is applied.

A subfield in which the first driving pulse is applied may be different from a subfield to which the second driving pulse is applied.

The first driving pulse and the second driving pulse each may have different waveforms in at least one of a reset period, an address period or a sustain period.

The plasma display apparatus may further comprise at least one control board for supplying a control signal to each of at least two scan drivers, wherein at least two scan drivers each are formed on different driving boards.

At least one control board may comprise a first control board and a second control board, the first control board supplies the control signal to one scan driver, and the second control board supplies the control signal to the other scan driver.

At least two scan drivers are connected through a connecter.

At least two scan drivers each are formed on different printed circuit boards.

According to an aspect, there is provided a method of driving a plasma display apparatus comprising supplying a first driving pulse to the plurality of scan electrodes and supplying a second driving pulse to the plurality of scan electrodes, wherein the first driving pulse and the second driving pulse are supplied at application time points different from each other.

Hereinafter, exemplary embodiments of the present invention will be described in detail with reference to the attached drawings.

### First Embodiment

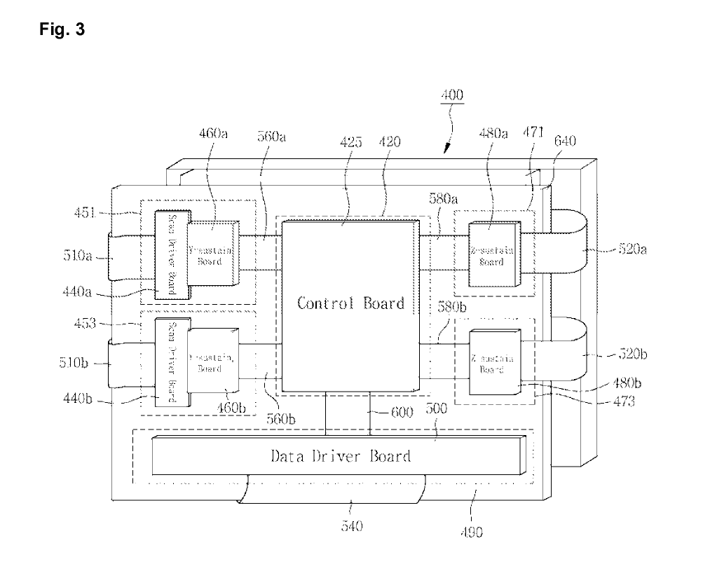

FIG. 3 shows a plasma display apparatus according to a first embodiment of the present invention. As shown in FIG. 3, the plasma display apparatus according to the first embodiment of the present invention comprises a plasma display panel 400, n-numbered scan drivers 451 and 453, m-numbered sustain drivers 471 and 473, a data driver 490 and a controller 420. Here, n and m are a natural number of 2 or more, respectively. A reference numeral 640 denotes a heat sink.

The plasma display panel 400 comprises a plurality of scan electrodes and a plurality of sustain electrodes.

The n-numbered scan drivers 451 and 453 supply a reset pulse during a reset period, a scan pulse during an address period and a sustain pulse during a sustain period to the scan electrodes of the plasma display panel 400.

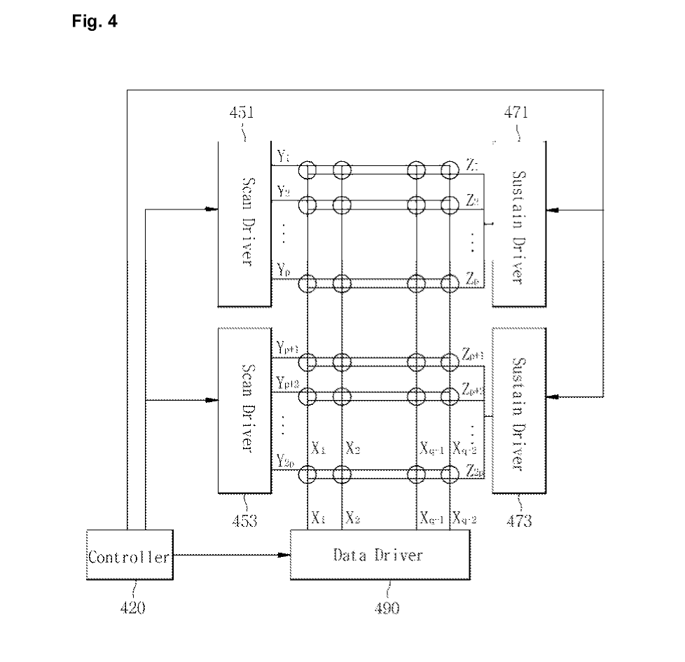

The plurality of scan electrodes according to the first embodiment of the present invention are divided into n-numbered scan electrode groups. The n-numbered scan drivers 451 and 453 supply a driving pulse to each of the n-numbered scan electrode groups. As shown in FIG. 4, for example, one scan driver 451 supplies the driving pulse to one of two scan electrode groups and the other scan driver 453 supplies the driving pulse to the other scan electrode group.

The scan drivers 451 and 453 each comprise scan driver boards 440a and 440b generating the reset pulse and the scan pulse during the reset period and the address period and Y-sustain boards 460a and 460b generating the sustain pulse during the sustain period.

The scan driver boards 440a and 440b supply the reset pulse or the scan pulse to the scan electrode groups through Y-flexible printed circuits (Y-FPCs) 510a and 510b.

The Y-sustain boards 460a and 460b supply the sustain pulse to the scan electrode groups through the scan driver boards 440a and 440b and the Y-FPCs 510a and 510b.

The m-numbered sustain drivers 471 and 473 supply a sustain pulse to the sustain electrodes of the plasma display panel 400 during the sustain period.

The plurality of sustain electrodes according to the first embodiment of the present invention are divided into m-numbered sustain electrode groups. The r-numbered sustain drivers 471 and 473 supply a driving pulse to each of the m-numbered scan electrode groups. As shown in FIG. 4, for example, one sustain driver 471 supplies the driving pulse to one of two sustain electrode groups and the other sustain driver 473 supplies the driving pulse to the other sustain electrode group.

The sustain drivers 471 and 473 each comprise Z-sustain boards 480a and 480b generating the sustain pulse during the sustain period.

The Z-sustain boards 480a and 480b supply the sustain pulse to the sustain electrode groups through Z-FPCs 520a and 520b.

The data driver 490 comprises a data driver board 500 generating a data pulse during the address period. The data driver board 500 supplies the data pulse to address electrodes through a X-FPC 540.

The controller 420 comprises a control board 425 generating a timing control signal of each of the n-numbered scan drivers 451 and 453, the m-numbered sustain drivers 471 and 473 and the data driver 490. The controller 420 supplies a Y-timing control signal to the n-numbered scan drivers 451 and 453 through n-numbered first FPCs 560a and 560b, a Z-timing control signal to the m-numbered sustain drivers 451 and 453 through m-numbered second FPCs 580a and 580b, and a X-timing control signal to the data driver 490 through a third FPC 600.

The plasma display apparatus according to the first embodiment of the present invention comprises the plurality of scan drivers 451 and 453 and the plurality of sustain drivers 471 and 473. However, the plasma display apparatus may comprise one scan driver and the plurality of sustain drivers. Further, the plasma display apparatus may comprise the plurality of scan drivers and one sustain driver.

FIG. 4 illustrates a relationship between drivers and electrodes of the plasma display apparatus according to the first embodiment of the present invention. As shown in FIG. 4, the scan driver 451 supplies the reset pulse, the scan pulse and the sustain pulse to one of two scan electrode groups. One scan electrode group comprises a first scan electrode Y₁ to a p-th scan electrode Yₚ. The scan driver 453 supplies the reset pulse, the scan pulse and the sustain pulse to the other scan electrode group. The other scan electrode group comprises a p+1-th scan electrode Yₚ₊₁ to a 2p-th scan electrode Y₂ₚ.

The sustain driver 471 supplies the sustain pulse to one of two sustain electrode groups. One sustain electrode group comprises a first sustain electrode Z₁ to a p-th sustain electrode Zₚ. The sustain driver 473 supplies the sustain pulse to the other sustain electrode group. The other sustain electrode group comprises a p+1-th sustain electrode Zₚ₊₁ to a 2p-th sustain electrode Z₂ₚ.

As shown in FIG. 4, the number of scan electrodes of each of the n-numbered scan electrode groups may be equal to one another. Further, the number of scan electrodes of at least one of the n-numbered scan electrode groups may be different from the number of scan electrodes of the remaining scan electrode group. The number of sustain electrodes of each of the m-numbered sustain electrode groups may be equal to one another. Further, the number of sustain electrodes of at least one of the m-numbered sustain electrode groups may be different from the number of sustain electrodes of the remaining sustain electrode group.

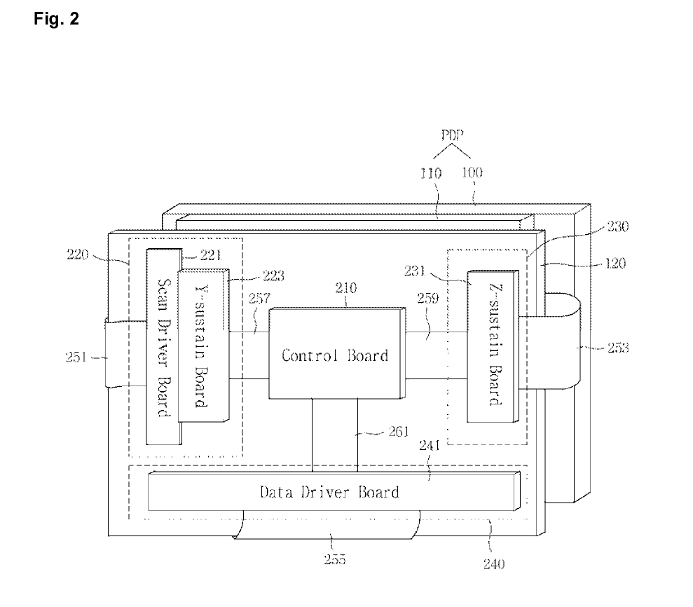

As shown in FIGS. 3 and 4, the size of a driving board on which one scan driver or one sustain driver is mounted is smaller than the size of the driving board included in the related art plasma display apparatus of FIG. 2. Accordingly, it is easy to manipulate the scan driver or the sustain driver.

Since one driving board supplies a driving pulse to all electrodes in the related art plasma display apparatus of FIG. 2, the size of the driving board is large. Therefore, the manufacturing cost of the plasma display apparatus increases. However, since one driving board supplies the driving pulse to one electrode group in the first embodiment of the present invention, the size of the driving board is smaller than the size of the driving board of FIG. 2. Accordingly, the manufacturing cost of the plasma display apparatus decreases.

Since one driving board supplies the driving pulse to all of the electrodes in the related art plasma display apparatus of FIG. 2, a control process is complicated and a driving margin decreases. However, since one driving board supplies the driving pulse to the scan electrode group or the sustain electrode group in the first embodiment of the present invention, a control process is relatively simple and a driving margin is secured.

Further, the energy consumption generated by supplying the driving pulse to the scan electrode group or the sustain electrode group by one scan driver or one sustain driver is less than the energy consumption generated by supplying the driving pulse to all of the scan electrodes or all of the sustain electrodes by one scan driver or one sustain driver in FIG. 2.

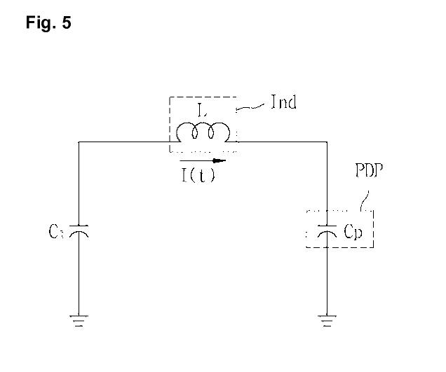

FIG. 5 illustrates the energy consumption of the plasma display apparatus according to the first embodiment of the present invention. As shown in FIG. 5, when an energy storing capacitor c1 supplies an energy to the plasma display panel, a resonance between a capacitor component of the panel and an inductor Ind is formed.

A current I(t) flowing in the inductor Ind is expressed by the following Equation 1.

$$I ( t ) = Vs \sqrt{\frac{Cp}{L}} sin \sqrt{LCp} t \qquad [ Equation 1 ]$$

In the above Equation 1, I(t) is a current flowing from the energy storing capacitor c1 to the plasma display panel. L is an inductance of the inductor Ind. Cp is a capacitance of the capacitor component of the plasma display panel. Vs is a sustain voltage for maintaining a sustain discharge.

The energy consumption W by the current I(t) flowing in the inductor Ind and a parasitic resistance R existing in a practical circuit is expressed by the following Equation 2. That is, as shown in FIG. 2, the energy consumption W generated by supplying the driving pulse to all of the scan electrodes or all of the sustain electrodes by one scan driver or one sustain driver is expressed by the following Equation 2.

$$W = \frac{1}{8} π {Vs}^{2} Cp R \sqrt{\frac{Cp}{L}} \qquad [ Equation 2 ]$$

As in the above Equation 2, the energy consumption W is proportional to the capacitance Cp of the capacitor component of the plasma display panel and inversely proportional to the inductance L of the inductor Ind. When the energy consumption W increases, the driving efficiency of the plasma display panel decreases. In particular, as the plasma display apparatus becomes larger and supports high definition, the capacitance Cp increases. As a result, the driving efficiency of the plasma display panel decreases.

As shown in FIGS. 3 and 4, one scan driver or one sustain driver supplies the driving pulse to half of all of the scan electrodes or half of all of the sustain electrodes. Accordingly, in the above Equation 2, the capacitance Cp and the inductance L are changed into Cp/2 and 2L, respectively. The energy consumption W generated by the driving pulse supplied to two scan electrode groups is expressed by the following Equation 3.

$$W = \frac{1}{8} π {Vs}^{2} ( \frac{Cp}{2} ) R \sqrt{\frac{0.5 Cp}{2 L}} + \frac{1}{8} π {Vs}^{2} ( \frac{Cp}{2} ) R \sqrt{\frac{0.5 Cp}{2 L}} = \frac{1}{2} ⨯ ( \frac{1}{8} π {Vs}^{2} CpR \sqrt{\frac{Cp}{L}} ) \qquad [ Equation 3 ]$$

When comparing the above Equations 2 and 3, the energy consumption in the first embodiment of the present invention is less than the energy consumption of the related art plasma display apparatus of FIG. 2.

### Second Embodiment

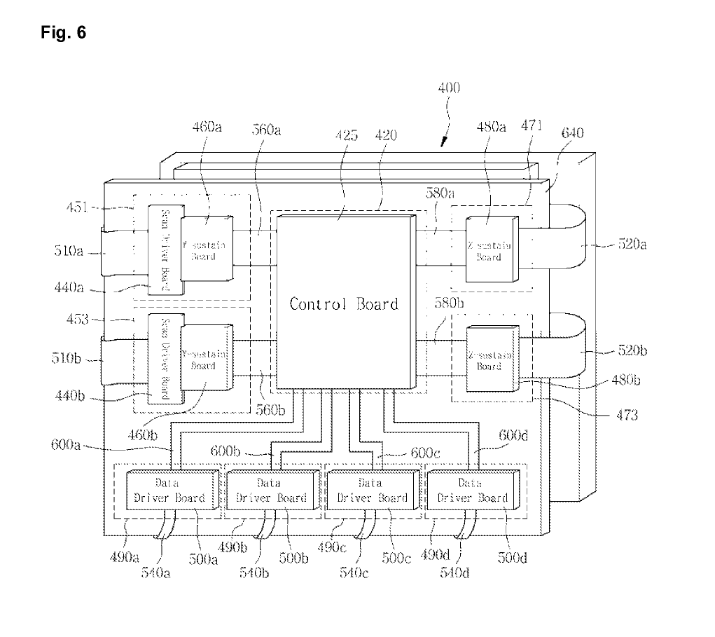

FIG. 6 shows a plasma display apparatus according to a second embodiment of the present invention. As shown in FIG. 6, the plasma display apparatus according to the second embodiment of the present invention comprises a plasma display panel 400, n-numbered scan drivers 451 and 453, m-numbered sustain drivers 471 and 473, r-numbered data drivers 490a to 490d and a controller 420. Here, n, m and r are a natural number of 2 or more, respectively. A reference numeral 640 denotes a heat sink.

The plasma display panel 400 comprises a plurality of scan electrodes, a plurality of sustain electrodes and a plurality of address electrodes.

Since structures of the n-numbered scan drivers 451 and 453 and the m-numbered sustain drivers 471 and 473 are the same as those of the first embodiment, the description thereabout is briefly made or is entirely omitted.

The plurality of scan electrodes are divided into n-numbered scan electrode groups. The n-numbered scan drivers 451 and 453 supply a driving pulse to each of the n-numbered scan electrode groups.

Scan driver boards 440a and 440b supply a reset pulse or a scan pulse to each of the scan electrode groups through Y-FPCs 510a and 510b. Y-sustain boards 460a and 460b supply a sustain pulse to each of the scan electrode groups through the scan driver boards 440a and 440b and the Y-FPCs 510a and 510b.

The plurality of sustain electrodes are divided into m-numbered sustain electrode groups. The m-numbered sustain drivers 471 and 473 supply a driving pulse to each of the m-numbered sustain electrode groups.

Z-sustain boards 480a and 480b supply a sustain pulse to each of the sustain electrode groups through Z-FPCs 520a and 520b.

The r-numbered data drivers 490a, 490b, 490c and 490d each comprise data driver boards 500a, 500b, 500c and 500d generating a data pulse during an address period. The data driver boards 500a, 500b, 500c and 500d each supply the data pulse to the plurality of address electrodes through X-FPCs 540a, 540b, 540c and 540d, which are connected to the data driver boards 500a, 500b, 500c and 500d, respectively. Therefore, the plurality of address electrodes are divided into r-numbered address electrode groups.

The controller 420 comprises a control board 425 generating a timing control signal of each of the n-numbered scan drivers 451 and 453, the m-numbered sustain drivers 471 and 473 and the r-numbered data drivers 490a, 490b, 490c and 490d.

The controller 420 supplies a Y-timing control signal to the n-numbered scan drivers 451 and 453 through n-numbered first FPCs 560a and 560b, a Z-timing control signal to the m-numbered sustain drivers 471 and 473 through m-numbered second FPCs 580a and 580b, and a X-timing control signal to the r-numbered data drivers 490a, 490b, 490c and 490d through r-numbered third FPCs 600a, 600b, 600c and 600d.

The plasma display apparatus according to the second embodiment of the present invention comprises the plurality of scan drivers 451 and 453 and the plurality of sustain drivers 471 and 473. However, the plasma display apparatus may comprise one scan driver and the plurality of sustain drivers. Further, the plasma display apparatus may comprise the plurality of scan drivers and one sustain driver.

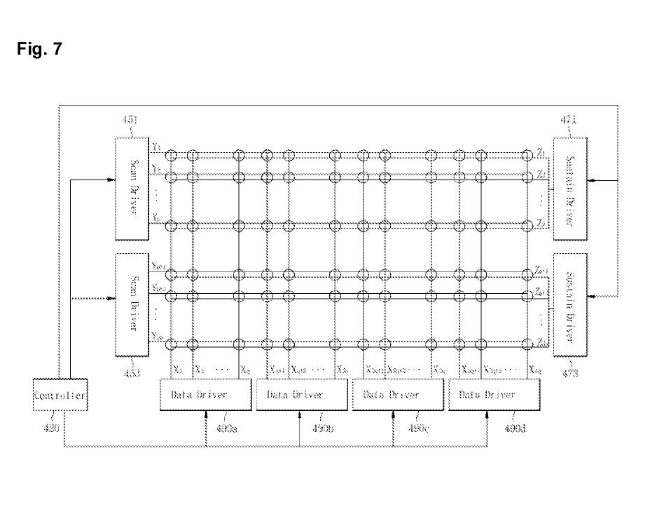

FIG. 7 illustrates a relationship between drivers and electrodes of the plasma display apparatus according to the second embodiment of the present invention. Since a relationship between the n-numbered scan drivers and the scan electrodes and a relationship between the m-numbered sustain drivers and the sustain electrodes are the same as those of the first embodiment of the present invention, the description thereabout is briefly made or is entirely omitted.

As shown in FIG. 7, the number of scan electrodes of each of the scan electrode groups may be equal to one another. Further, the number of scan electrodes of at least one of the n-numbered scan electrode groups may be different from the number of scan electrodes of the remaining scan electrode group.

The number of sustain electrodes of each of the sustain electrode groups may be equal to one another. Further, the number of sustain electrodes of at least one of the m-numbered sustain electrode groups may be different from the number of sustain electrodes of the remaining sustain electrode group.

Since the plasma display apparatus according to the second embodiment comprises the r-numbered data drivers 490a, 490b, 490c and 490d, all of the address electrodes are divided into the r-numbered address electrode groups. The number of address electrodes of each of the address electrode groups may be equal to one another. Further, the number of address electrodes of at least one of the r-numbered address electrode groups may be different from the number of address electrodes of the remaining address electrode group.

Under the timing control of the controller 420, when the n-numbered scan drivers 451 and 453 supply the scan pulse to all of the scan electrodes Y₁, Y₂, Y₃, . . . Y₂ₚ, the r-numbered data drivers 490a, 490b, 490c and 490d supply the address pulse synchronized with the scan pulse to all of the address electrodes X₁, X₂, X₃, . . . , X_{4q}.

As shown in FIGS. 6 and 7, the size of a driving board on which one scan driver, one sustain driver or one data driver is mounted is smaller than the size of the driving board included in the related art plasma display apparatus of FIG. 2. Therefore, it is easy to manipulate the driving board.

Since one driving board supplies a driving pulse to all electrodes in the related art plasma display apparatus of FIG. 2, the size of the driving board is large. Accordingly, the manufacturing cost of the plasma display apparatus increases. However, since one driving board supplies the driving pulse to one electrode group in the second embodiment of the present invention, the size of the driving board is smaller than the size of the driving board of FIG. 2. Accordingly, the manufacturing cost of the plasma display apparatus decreases.

Since one driving board supplies the driving pulse to all of the electrodes in the related art plasma display apparatus of FIG. 2, a control process is complicated and a driving margin decreases. However, since one driving board supplies the driving pulse to one scan electrode group, one sustain electrode group or one address electrode group in the second embodiment of the present invention, a control process is relatively simple and a driving margin is secured.

Since one driving board supplies the driving pulse to one electrode group in the second embodiment of the present invention, the energy consumption, as shown in the above Equation 3, is less than the energy consumption in FIG. 2 and a driving efficiency of the plasma display panel increases.

### Third Embodiment

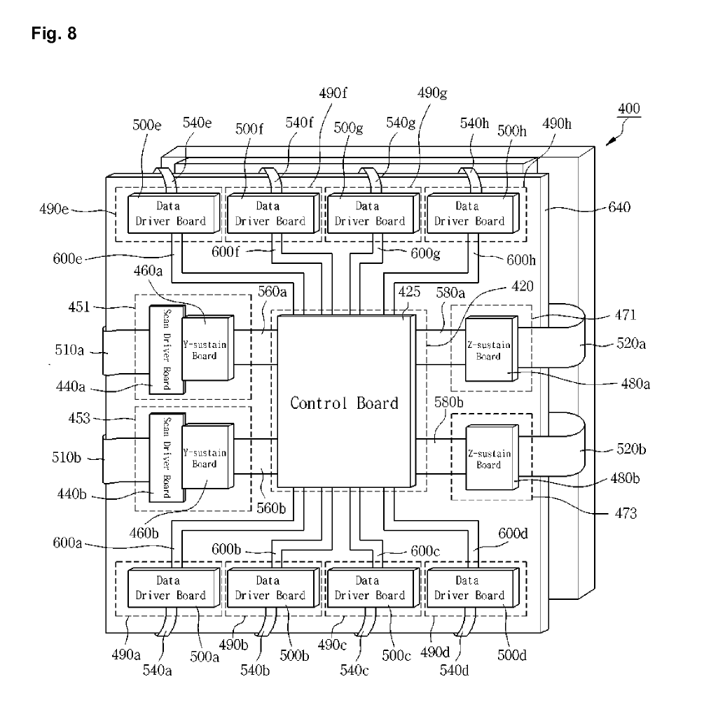

FIG. 8 shows a plasma display apparatus according to a third embodiment of the present invention. As shown in FIG. 8, the plasma display apparatus according to the third embodiment of the present invention comprises a plasma display panel 400, n-numbered scan drivers 451 and 453, m-numbered sustain drivers 471 and 473, s-numbered data drivers 490a to 490h and a controller 420. Here, n, m and s are a natural number of 2 or more, respectively. One or more data drivers of the s-numbered data drivers 490a to 490h are formed to be opposed to the remaining data drivers. A reference numeral 640 denotes a heat sink.

The plasma display panel 400 comprises a plurality of scan electrodes, a plurality of sustain electrodes and a plurality of address electrodes.

Since structures of the n-numbered scan drivers 451 and 453 and the m-numbered sustain drivers 471 and 473 are the same as those of the first embodiment, the description thereabout is briefly made or is entirely omitted.

The plurality of scan electrodes are divided into n-numbered scan electrode groups. The n-numbered scan drivers 451 and 453 supply a driving pulse to each of the n-numbered scan electrode groups.

Since a connection relationship between scan driver board 440a and 440b, Y-sustain boards 460a and 460b and Y-FPCs 510a and 510b and the scan electrode groups and the driving pulse is the same as that of the first embodiment, the description thereabout is briefly made or is entirely omitted.

The plurality of sustain electrodes are divided into m-numbered sustain electrode groups. The m-numbered sustain drivers 471 and 473 supply a driving pulse to each of the m-numbered sustain electrode groups.

Since a connection relationship between Z-sustain board 480a and 480b and Z-FPCs 520a and 520b and the sustain electrode groups and the driving pulse is the same as the first embodiment, the description thereabout is briefly made or is entirely omitted.

The s-numbered data drivers 490a to 490h comprise data driver boards 500a to 500h generating a data pulse during an address period. The data driver boards 500a to 500h supply the data pulse to the plurality of address electrodes through X-FPCs 540a to 540h, which are connected to the data driver boards 500a to 500h, respectively. Therefore, the plurality of address electrodes are divided into s-numbered address electrode groups.

The controller 420 comprises a control board 425 generating a timing control signal of each of the n-numbered scan drivers 451 and 453, the m-numbered sustain drivers 471 and 473 and the s-numbered data drivers 490a to 490h.

The controller 420 supplies a Y-timing control signal to the n-numbered scan drivers 451 and 453 through n-numbered first FPCs 560a and 560b, a Z-timing control signal to the m-numbered sustain drivers 471 and 473 through m-numbered second FPCs 580a and 580b, and a X-timing control signal to the s-numbered data drivers 490a to 490h through s-numbered third FPCs 600a to 600h.

The plasma display apparatus according to the third embodiment of the present invention comprises the plurality of scan drivers 451 and 453 and the plurality of sustain drivers 471 and 473. However, the plasma display apparatus may comprise one scan driver and the plurality of sustain drivers. Further, the plasma display apparatus may comprise the plurality of scan drivers and one sustain driver.

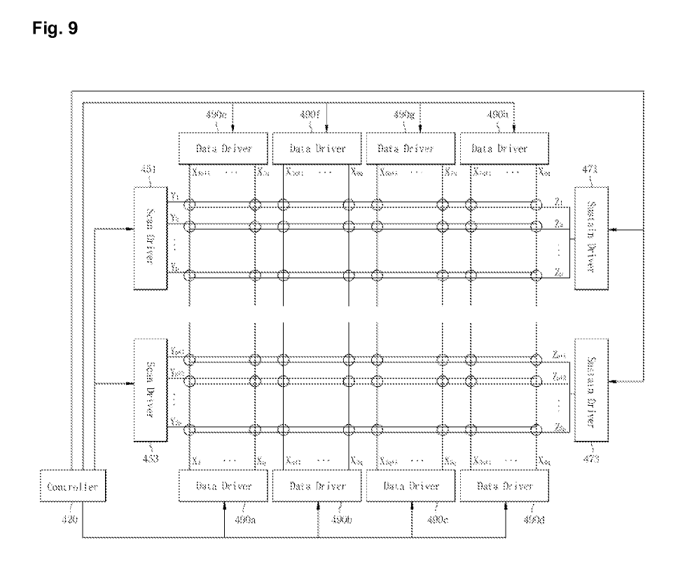

FIG. 9 illustrates a relationship between drivers and electrodes of the plasma display apparatus according to the third embodiment of the present invention. Since a relationship between the n-numbered scan drivers and the scan electrodes and a relationship between the m-numbered sustain drivers and the sustain electrodes are the same as those of the first embodiment of the present invention, the description thereabout is briefly made or is entirely omitted.

As shown in FIG. 9, the number of scan electrodes of each of the scan electrode groups may be equal to one another. Further, the number of scan electrodes of at least one of the n-numbered scan electrode groups may be different from the number of scan electrodes of the remaining scan electrode group.

The number of sustain electrodes of each of the sustain electrode groups may be equal to one another. Further, the number of sustain electrodes of at least one of the m-numbered sustain electrode groups may be different from the number of sustain electrodes of the remaining sustain electrode group.

Since the plasma display apparatus according to the third embodiment comprises the s-numbered data drivers 490a to 490h, all of the address electrodes are divided into the s-numbered address electrode groups. All of the address electrodes are divided in a perpendicular direction to the formation direction thereof. One region, in which all of the address electrodes are located, is divided into two regions with respect to the perpendicular direction. Some data drivers 490a to 490d of the data drivers 490a to 490h supply an address pulse to discharge cells located in one region of two regions. The remaining data drivers 490e to 490h supply an address pulse to discharge cells located in the other region.

The number of address electrodes of each of the address electrode groups may be equal to one another. Further, the number of address electrodes of at least one of the s-numbered address electrode groups may be different from the number of address electrodes of the remaining address electrode group.

Under the timing control of the controller 420, when the n-numbered scan drivers 451 and 453 supply a scan pulse to all of the scan electrodes Y₁, Y₂, Y₃, . . . Y₂ₚ, the s-numbered data drivers 490a to 490h supply an address pulse synchronized with the scan pulse to all of the address electrodes X₁, X₂, X₃, . . . , X_{2q}.

Since the address electrodes are cut, the scan drivers 451 and 453 can be driven independently. For example, when the scan driver 451 supplies a scan pulse to the first scan electrode Y₁, the scan driver 453 can supply a scan pulse to the p+1-th scan electrode Yₚ₊₁. The data drivers 490a to 490d supply an address pulse synchronized with the scan pulse supplied to the p+1-th scan electrode Yₚ₊₁ to the address electrodes X₁ to X_{4q}. The data drivers 490e t0 490h supply an address pulse synchronized with the scan pulse supplied to the first scan electrode Y₁ to the address electrodes X_{4q+1} to X_{8q}.

As shown in FIGS. 8 and 9, the size of a driving board on which one scan driver, one sustain driver or one data driver is mounted is smaller than the size of the driving board included in the related art plasma display apparatus of FIG. 2. Therefore, it is easy to manipulate the driving board.

Since one driving board supplies a driving pulse to all electrodes in the related art plasma display apparatus of FIG. 2, the size of the driving board is large. Accordingly, the manufacturing cost of the plasma display apparatus increases. However, since one driving board supplies the driving pulse to one electrode group in the third embodiment of the present invention, the size of the driving board is smaller than the size of the driving board of FIG. 2. Accordingly, the manufacturing cost of the plasma display apparatus decreases.

Since one driving board supplies the driving pulse to all of the electrodes in the related art plasma display apparatus of FIG. 2, a control process is complicated and a driving margin decreases. However, since one driving board supplies the driving pulse to one scan electrode group, one sustain electrode group or one address electrode group in the third embodiment of the present invention, a control process is relatively simple and a driving margin is secured.

Since one driving board supplies the driving pulse to one electrode group in the third embodiment of the present invention, the energy consumption, as shown in the above Equation 3, is less than the energy consumption in FIG. 2 and a driving efficiency of the plasma display panel increases.

### Fourth Embodiment

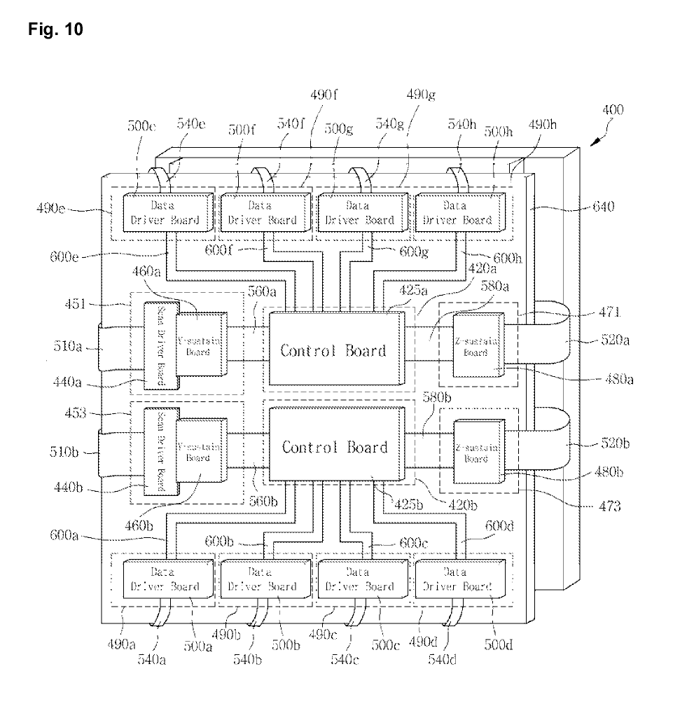

FIG. 10 shows a plasma display apparatus according to a fourth embodiment of the present invention. As shown in FIG. 10, the plasma display apparatus according to the fourth embodiment of the present invention comprises a plasma display panel 400, n-numbered scan drivers 451 and 453, m-numbered sustain drivers 471 and 473, s-numbered data drivers 490a to 490h and a plurality of controllers 420a and 420b. Here, n, m and s are a natural number of 2 or more, respectively. One or more data drivers of the s-numbered data drivers 490a to 490h are formed to be opposed to the remaining data drivers. A reference numeral 640 denotes a heat sink.

The plasma display panel 400 comprises a plurality of scan electrodes, a plurality of sustain electrodes and a plurality of address electrodes.

Since structures of the n-numbered scan drivers 451 and 453 and the m-numbered sustain drivers 471 and 473 are the same as those of the first embodiment, the description thereabout is briefly made or is entirely omitted.

The plurality of scan electrodes are divided into n-numbered scan electrode groups. The n-numbered scan drivers 451 and 453 supply a driving pulse to each of the n-numbered scan electrode groups.

Since a connection relationship between scan driver board 440a and 440b, Y-sustain boards 460a and 460b and Y-FPCs 510a and 510b and the scan electrode groups and the driving pulse is the same as that of the first embodiment, the description thereabout is briefly made or is entirely omitted.

The plurality of sustain electrodes are divided into m-numbered sustain electrode groups. The m-numbered sustain drivers 471 and 473 supply a driving pulse to each of the m-numbered sustain electrode groups.

Since a connection relationship between Z-sustain board 480a and 480b and Z-FPCs 520a and 520b and the sustain electrode groups and the driving pulse is the same as that of the first embodiment, the description thereabout is briefly made or is entirely omitted.

A connection relationship between the s-numbered data drivers 490a to 490h and X-FPCs 540a to 540h is the same as that of the third embodiment. Accordingly, the address electrodes are divided into s-numbered address electrode groups.

The plurality of controllers 420a and 420b comprise control boards 425a and 425b generating a timing control signal of each of the n-numbered scan drivers 451 and 453, the m-numbered sustain drivers 471 and 473 and the s-numbered data drivers 490a to 490h.

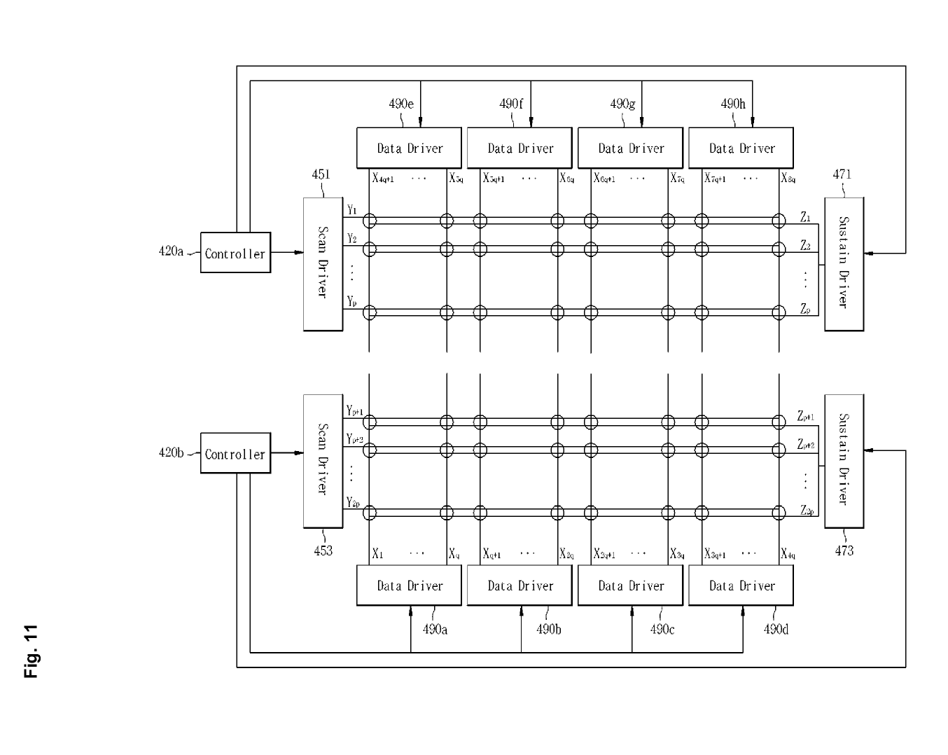

As shown in FIG. 11, the controller 420a supplies a X-timing control signal to some data drivers 490a to 490d of the s-numbered data drivers 490a to 490h through third FPCs 600a to 600d. Further, the controller 420b supplies a X-timing control signal to the remaining data drivers 490e to 490h through third FPCs 600e to 600h.

In other words, the plurality of controllers 420a and 420b each control one or more scan drivers, one or more sustain drivers and one or more data drivers.

The plasma display apparatus according to the fourth embodiment of the present invention comprises the plurality of scan drivers 451 and 453 and the plurality of sustain drivers 471 and 473. However, the plasma display apparatus may comprise one scan driver and the plurality of sustain drivers. Further, the plasma display apparatus may comprise the plurality of scan drivers and one sustain driver.

FIG. 11 illustrates a relationship between drivers and electrodes of the plasma display apparatus according to the fourth embodiment of the present invention. Since a relationship between the n-numbered scan drivers 451 and 453 and the scan electrodes and a relationship between the m-numbered sustain drivers 471 and 473 and the sustain electrodes are the same as those of the first embodiment of the present invention, the description thereabout is briefly made or is entirely omitted.

As shown in FIG. 11, the number of scan electrodes of each of the scan electrode groups may be equal to one another. Further, the number of scan electrodes of at least one of the n-numbered scan electrode groups may be different from the number of scan electrodes of the remaining scan electrode group.

The number of sustain electrodes of each of the sustain electrode groups may be equal to one another. Further, the number of sustain electrodes of at least one of the m-numbered sustain electrode groups may be different from the number of sustain electrodes of the remaining sustain electrode group.

Since a driving method of the fourth embodiment of the present invention is the same as that of the third embodiment of the present invention, the description thereabout is briefly made or is entirely omitted. Only, one of the plurality of controllers 420a and 420b supplies the timing control signal to at least one of the n-numbered scan drivers 451 and 453, the timing control signal to at least one of the m-numbered sustain drivers 471 and 473, and the timing control signal to at least one of the s-numbered data drivers 490a to 490h.

For example, as shown in FIG. 11, some data drivers 490a to 490d of the s-numbered data drivers 490a to 490h supply the address pulse to discharge cells located in one region according to the timing control signal supplied from the controller 420a. Further, the remaining data drivers 490e to 490h supply the address pulse to discharge cells located in the other region according to the timing control signal supplied from the controller 420b.

As shown in FIGS. 10 and 11, the size of the driving board on which one scan driver, one sustain driver or one data driver is mounted is smaller than the size of the driving board included in the related art plasma display apparatus of FIG. 2. Therefore, it is easy to manipulate the driving board.

Since one driving board supplies a driving pulse to all electrodes in the related art plasma display apparatus of FIG. 2, the size of the driving board is large. Accordingly, the manufacturing cost of the plasma display apparatus increases. However, since one driving board supplies the driving pulse to one electrode group in the fourth embodiment of the present invention, the size of the driving board is smaller than the size of the driving board of FIG. 2. Accordingly, the manufacturing cost of the plasma display apparatus decreases.

Since one driving board supplies the driving pulse to all of the electrodes in the related art plasma display apparatus of FIG. 2, a control process is complicated and a driving margin decreases. However, since one driving board supplies the driving pulse to one scan electrode group, one sustain electrode group or one address electrode group in the fourth embodiment of the present invention, a control process is relatively simple and a driving margin is secured.

Since one driving board supplies the driving pulse to one electrode group in the fourth embodiment of the present invention, the energy consumption, as shown in the above Equation 3, is less than the energy consumption in FIG. 2 and a driving efficiency of the plasma display panel increases.

### Fifth Embodiment

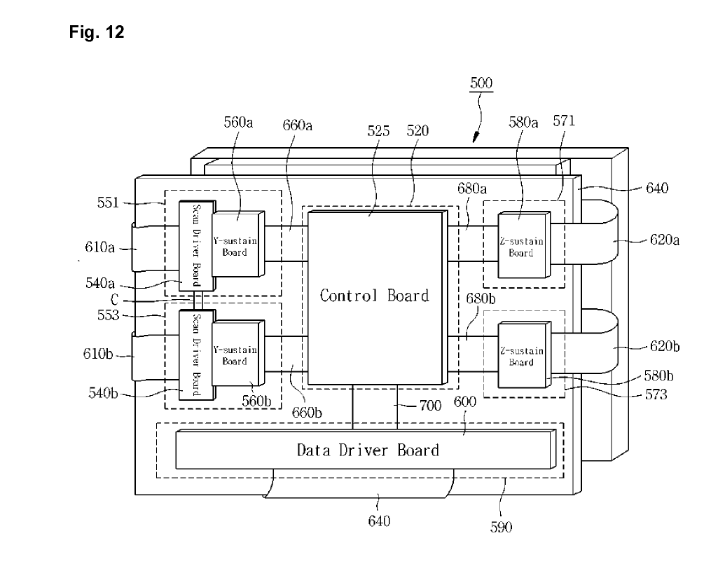

FIG. 12 shows a plasma display apparatus according to a fifth embodiment of the present invention. As shown in FIG. 12, the plasma display apparatus according to the fifth embodiment of the present invention comprises a plasma display panel 500, n-numbered scan drivers 551 and 553, a connecter C, m-numbered sustain drivers 571 and 573, a data driver 590 and a controller 520. Here, n and m are a natural number of 2 or more, respectively. A reference numeral 640 denotes a heat sink.

The plasma display panel 500 comprises a plurality of scan electrodes, a plurality of sustain electrodes and a plurality of address electrodes.

The n-numbered (n is a natural number of 2 or more) scan drivers 551 and 553 supply a reset pulse during a reset period, a scan pulse during an address period and a sustain pulse during a sustain period to the scan electrodes of the plasma display panel 500. The plurality of scan electrodes according to the fifth embodiment of the present invention are divided into n-numbered scan electrode groups. The n-numbered scan drivers 551 and 553 supply a driving pulse to each of the n-numbered scan electrode groups.

In the fifth embodiment of the present invention, the n-numbered scan drivers 551 and 553 are connected to one another by the n-1-numbered connecters C. For example, when the scan driver 551 produces one driving pulse, the scan driver 553 receives one driving pulse through the connecter C. In other words, one scan driver 551 supplies one driving pulse to one scan electrode group. The other scan driver 553 receives one driving pulse through the connecter C, and then supplies one driving pulse to the other scan electrode group.

The scan drivers 551 and 553 each comprise scan driver boards 540a and 540b generating the reset pulse and the scan pulse during the reset period and the address period and Y-sustain boards 560a and 560b generating the sustain pulse during the sustain period. The n-1-numbered connecters C electrically connect the n-numbered scan driver boards 540a and 540b to one another. The scan driver boards 540a and 540b and Y-sustain boards 560a and 560b each are Printed Circuit Boards

The scan driver boards 540a and 540b supply the reset pulse or the scan pulse to each of the scan electrode groups through Y-FPCs 610a and 610b.

The Y-sustain boards 560a and 660b supply the sustain pulse to each of the scan electrode groups through the scan driver boards 540a and 540b and the Y-FPCs 610a and 610b. The scan driver boards 540a and 540b each supply the received reset pulse, the received scan pulse or the received sustain pulse to each of the scan electrode groups through the connecter C.

The m-numbered (m is a natural number of 1 or more) sustain drivers 571 and 573 supply a sustain pulse to the sustain electrodes of the plasma display panel 500 during the sustain period. The plurality of sustain electrodes according to the fifth embodiment of the present invention are divided into m-numbered sustain electrode groups. The m-numbered sustain drivers 571 and 573 supply a driving pulse to each of the m-numbered scan electrode groups.

The sustain drivers 571 and 573 comprise Z-sustain boards 580a and 580b. The Z-sustain boards 580a and 580b supply the sustain pulse to each of the sustain electrode groups through Z-FPCs 620a and 620b.

The data driver 590 comprises a data driver board 600. The data driver board 600 supplies the data pulse to the address electrodes through a X-FPC 640. The data driver 590, as shown in FIG. 6, may be plural.

At least one controller 520 comprises a control board 525 generating a timing control signal of each of the n-numbered scan drivers 551 and 553, the m-numbered sustain drivers 571 and 573 and the data driver 590. First FPCs 660a and 660b, second FPCs 680a and 680b and a third FPC 700 are used to transmit the timing control signals to each of the scan, sustain, data drivers. On occasion of the plurality of controller, each controller is formed on one driving board. For example, on occasion of two controllers, one controller controls one scan driver 551 and one sustain driver 571, and the other controller controls the other scan driver 571 and the other sustain driver 573.

The plasma display apparatus according to the fifth embodiment of the present invention comprises the plurality of scan drivers 551 and 553 and the plurality of sustain drivers 571 and 573. However, the plasma display apparatus may comprise one scan driver and the plurality of sustain drivers. Further, the plasma display apparatus may comprise the plurality of scan drivers and one sustain driver.

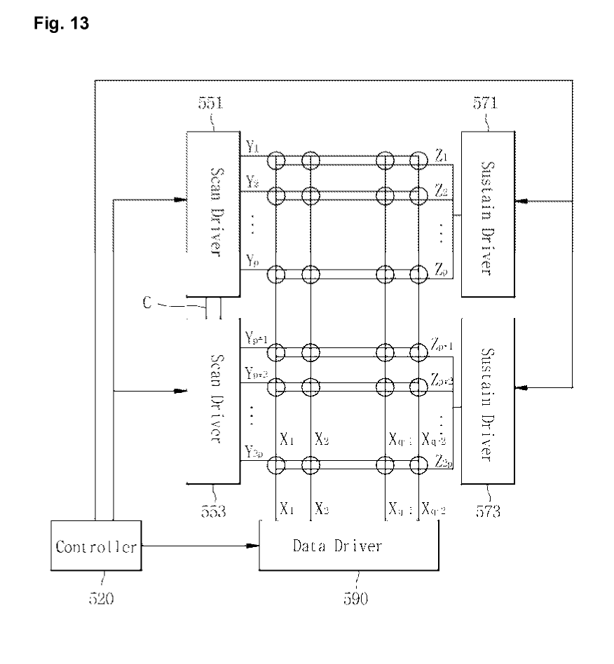

FIG. 13 illustrates a relationship between drivers and electrodes of the plasma display apparatus according to the fifth embodiment of the present invention. As shown in FIG. 13, the scan driver 551 supplies the reset pulse, the scan pulse and the sustain pulse to one of two scan electrode groups. The scan driver 553 supplies the reset pulse, the scan pulse and the sustain pulse to the other scan electrode group. The connecter C electrically connects the scan driver 551 to the scan driver 553.

The sustain driver 571 supplies the sustain pulse to one of two sustain electrode groups. The sustain driver 573 supplies the sustain pulse to the other sustain electrode group.

As shown in FIG. 13, the number of scan electrodes of each of the scan electrode groups may be equal to one another. Further, the number of scan electrodes of at least one of the n-numbered scan electrode groups may be different from the number of scan electrodes of the remaining scan electrode group. The number of sustain electrodes of each of the sustain electrode groups may be equal to one another. Further, the number of sustain electrodes of at least one of the m-numbered sustain electrode groups may be different from the number of sustain electrodes of the remaining sustain electrode group.

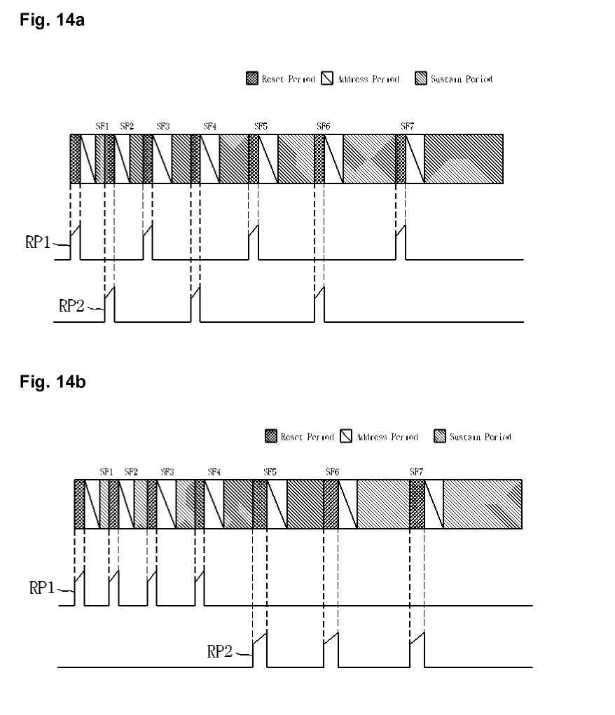

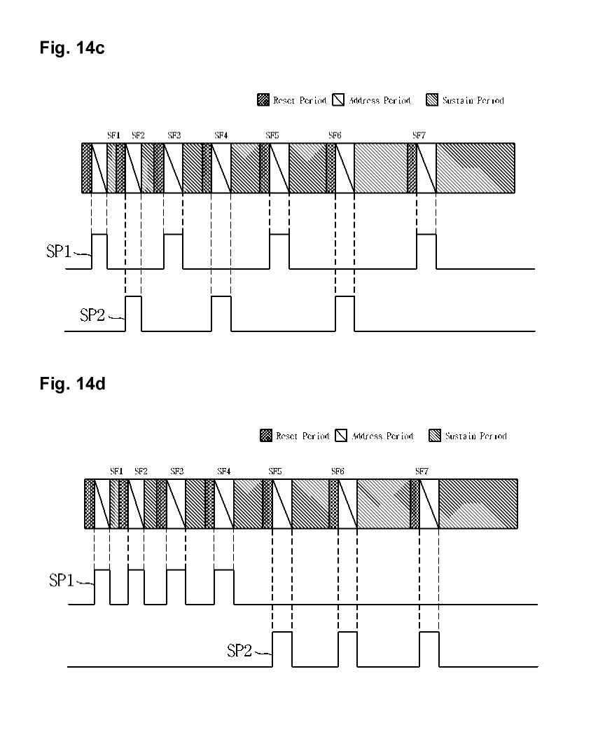

FIGS. 14a through 14d show a driving method of the plasma display apparatus according to the fifth embodiment of the present invention. FIGS. 14a through 14d show a driving method of the plasma display apparatus in a case where the plasma display apparatus according to the fifth embodiment of the present invention comprises two scan drivers and two sustain driver.

As shown in FIGS. 14a and 14b, a reset pulse RP1 produced by the scan driver board 540a is supplied during reset periods of one or more subfields of all subfields. A reset pulse RP2 produced by the scan driver board 540b is supplied during reset periods of the remaining subfields.

As shown in FIG. 14a, the reset pulse RP1 produced by the scan driver board 540a is supplied to all of the scan electrodes during reset periods of odd-numbered subfields of all of the subfields. The reset pulse RP2 produced by the scan driver board 540b is supplied to all of the scan electrodes during reset periods of the remaining even-numbered subfields.

In other words, the scan driver board 540a supplies the reset pulse RP1 to one scan electrode group during the reset periods of the odd-numbered subfields of all of the subfields. The scan driver board 540b receives the reset pulse RP1 through the connecter C, and then supplies the reset pulse RP1 to the other scan electrode group. Further, the scan driver board 540b supplies the reset pulse RP2 to the other scan electrode group during the reset periods of the even-numbered subfields of all of the subfields. The scan driver board 540a receives the reset pulse RP2 through the connecter C, and then supplies the reset pulse RP2 to one scan electrode group. At this time, a slope of the reset pulse RP1 may be different from a slope of the reset pulse RP2. A width of the reset pulse RP1 may be different from a width of the reset pulse RP2.

As shown in FIG. 14b, the reset pulse RP1 produced by the scan driver board 540a is supplied to the scan electrodes during reset periods of predetermined-numbered subfields of all of the subfields. The reset pulse RP2 produced by the scan driver board 540b is supplied to the scan electrodes during reset periods of the remaining subfields.

In other words, the scan driver board 540a supplies the reset pulse RP1 to one scan electrode group during reset periods of first to fourth subfields SF1 to SF4 of all of the subfields. The scan driver board 540b receives the reset pulse RP1 through the connecter C, and then supplies the reset pulse RP1 to the other scan electrode group. Further, the scan driver board 540b supplies the reset pulse RP2 to the other scan electrode group during reset periods of the remaining subfields of all of the subfields. The scan driver board 540a receives the reset pulse RP2 through the connecter C, and then supplies the reset pulse RP2 to one scan electrode group.

At this time, a slope of the reset pulse RP1 may be different from a slope of the reset pulse RP2. A width of the reset pulse RP1 may be different from a width of the reset pulse RP2.

As shown in FIGS. 14c and 14d, a scan pulse SP1 produced by the scan driver board 540a is supplied during address periods of one or more subfields of all of the subfields. A scan pulse SP2 produced by the scan driver board 540b is supplied during address periods of the remaining subfields.

As shown in FIG. 14c, the scan driver board 540a supplies the scan pulse SP1 to one scan electrode group during address periods of the odd-numbered subfields of all of the subfields. The scan driver board 540b receives the scan pulse SP1 through the connecter C, and then supplies the scan pulse SP1 to the other scan electrode group.

Further, the scan driver board 540b supplies the scan pulse SP2 to the other scan electrode group during address periods of the even-numbered subfields of all of the subfields. The scan driver board 540a receives the scan pulse SP2 through the connecter C, and then supplies the scan pulse SP2 to one scan electrode group.

At this time, the duration of the address period of the subfield when the scan pulse SP1 is supplied by the scan driver 540a may be different from the duration of the address period of the subfield when the scan pulse SP2 is supplied by the scan driver 540b.

As shown in FIG. 14d, the scan pulse SP1 produced by the scan driver board 540a is supplied to the scan electrodes during address periods of the predetermined-numbered subfields of all of the subfields. The scan pulse SP2 produced by the scan driver board 540b is supplied to the scan electrodes during address periods of the remaining subfields.

In other words, the scan driver board 540a supplies the scan pulse SP1 to one scan electrode group during address periods of the first to fourth subfields SF1 to SF4 of all of the subfields. The scan driver board 540b receives the scan pulse SP1 through the connecter C, and then supplies the scan pulse SP1 to the other scan electrode group. Further, the scan driver board 540b supplies the scan pulse SP2 to the other scan electrode group during address periods of fifth to seventh subfields SF5 to SF7 of all of the subfields. The scan driver board 540a receives the scan pulse SP2 through the connecter C, and then supplies the scan pulse SP2 to one scan electrode group.

At this time, the durations of the address period of the subfield when the scan pulse SP1 is supplied by the scan driver 540a may be different from the duration of the address period of the subfield when the scan pulse SP2 is supplied by the scan driver 540b.

One Y sustain board 560a and the other Y sustain board 560b supply sustain pulses in subfields or frames from each other. For example, one Y sustain board 560a supplies the sustain pulses in sustain periods of odd-numbered subfields (1th-subfield, 3rd-subfield and 7^{th-}subfield) or odd-numbered frames, and the other sustain board 560b supplies the sustain pulses in sustain periods of even-numbered subfields (2nd-subfield, 4th-subfield and 6^{th-}subfield) or even-numbered frames.

One scan driver board 540a and the other scan driver board 540b supply driving pulses in different frames. For example, one scan driver board 540a supplies the driving pulses in odd-numbered frames, and the other scan driver board 540b supplies the driving pulses in odd-numbered frames.

In the fifth embodiment of the present invention, the size of a driving board on which one scan driver or one sustain driver is mounted is smaller than the size of the driving board included in the related art plasma display apparatus of FIG. 2. Therefore, it is easy to manipulate the driving board.

Since one driving board supplies a driving pulse to all electrodes in the related art plasma display apparatus of FIG. 2, the size of the driving board is large. Accordingly, the manufacturing cost of the plasma display apparatus increases. However, since one driving board supplies the driving pulse to one electrode group in the fifth embodiment of the present invention, the size of the driving board is smaller than the size of the driving board of FIG. 2. Accordingly, the manufacturing cost of the plasma display apparatus decreases.

Since one driving board supplies the driving pulse to all of the electrodes in the related art plasma display apparatus of FIG. 2, a control process is complicated and a driving margin decreases. However, since one driving board supplies the driving pulse to one scan electrode group or one sustain electrode group in the fifth embodiment of the present invention, a control process is relatively simple and a driving margin is secured.

Since one driving board supplies the driving pulse to one electrode group in the fifth embodiment of the present invention, the energy consumption, as shown in the above Equation 3, is less than the energy consumption in FIG. 2 and a driving efficiency of the plasma display panel increases.

Since the reset pulse or the scan pulse is differently supplied according to the subfields in the fifth embodiment of the present invention, the plasma display panel is driven using various driving methods. For example, as shown in FIG. 14b, when representing a low level gray scale, the duration of a reset period of each of the first to fourth subfields SF1 to SF4, which are mainly used to represent the low level gray scale for securing the sufficient duration of a reset period, may be longer than the duration of a reset period of each of the fifth to seventh subfields SF5 to SF7.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel on which a plurality of scan electrodes, a plurality of sustain electrodes and a plurality of address electrodes are formed; and
at least two scan drivers for driving the plurality of scan electrodes,
wherein one of at least two scan drivers supply a first driving pulse to the plurality of scan electrodes,
the other scan driver supplies a second driving pulse to the plurality of scan electrodes, and
one scan driver and the other scan driver supply the first driving pulse and the second driving pulse at application time points different from each other.

2. The plasma display apparatus of claim 1, further comprising at least one sustain driver for driving the plurality of sustain electrodes.

3. The plasma display apparatus of claim 1, further comprising at least one data driver for driving the plurality of address electrodes.

4. The plasma display apparatus of claim 1, wherein the first driving pulse and the second driving pulse each comprise at least one of a reset pulse, a scan pulse or a sustain pulse.

5. The plasma display apparatus of claim 4, wherein the first driving pulse comprises a first reset pulse and the second driving pulse comprises a second reset pulse, and
a slope of the first reset pulse is different from a slope of the second reset pulse.

6. The plasma display apparatus of claim 1, wherein a frame in which the first driving pulse is applied is different from a frame to which the second driving pulse is applied.

7. The plasma display apparatus of claim 1, wherein a subfield in which the first driving pulse is applied is different from a subfield to which the second driving pulse is applied.

8. The plasma display apparatus of claim 1, wherein the first driving pulse and the second driving pulse each have different waveforms in at least one of a reset period, an address period or a sustain period.

9. The plasma display apparatus of claim 1, further comprising at least one control board for supplying a control signal to each of at least two scan drivers,
wherein at least two scan drivers each are formed on different driving boards.

10. The plasma display apparatus of claim 9, wherein at least one control board comprises a first control board and a second control board,
the first control board supplies the control signal to one scan driver, and
the second control board supplies the control signal to the other scan driver.

11. The plasma display apparatus of claim 9, wherein at least two scan drivers are connected through a connecter.

12. The plasma display apparatus of claim 9, wherein at least two scan drivers each are formed on different printed circuit boards.

13. A method of driving a plasma display apparatus comprising a plurality of scan electrodes, a plurality of sustain electrodes and a plurality of address electrodes, the method comprising:
supplying a first driving pulse to the plurality of scan electrodes; and
supplying a second driving pulse to the plurality of scan electrodes,
wherein the first driving pulse and the second driving pulse are supplied at application time points different from each other.

14. The method of claim 13, wherein the first driving pulse and the second driving pulse each comprise at least one of a reset pulse, a scan pulse or a sustain pulse.

15. The plasma display apparatus of claim 14, wherein the first driving pulse comprises a first reset pulse and the second driving pulse comprises a second reset pulse, and
a slope of the first reset pulse is different from a slope of the second reset pulse.

16. The method of claim 13, wherein a frame in which the first driving pulse is applied is different from a frame to which the second driving pulse is applied.

17. The method of claim 13, wherein a subfield in which the first driving pulse is applied is different from a subfield to which the second driving pulse is applied.

18. The method of claim 13, wherein the first driving pulse and the second driving pulse each have different waveforms in at least one of a reset period, an address period or a sustain period.
